(19) United States
(12) Patent Application Publication
(10) Pub. No.: US 2014/0326634 A1
(43) Pub. Date: Nov. 6, 2014

(54) Blister Assembly for the Storage and Distribution of Pills

(71) Applicant: Sandrine Milante, Chambly (CA)

(72) Inventor: Sandrine Milante, Chambly (CA)

(73) Assignee: EcoloPharm Inc., Chambly (CA)

(21) Appl. No.: 13/887,035

(22) Filed: May 3, 2013

(51) Int. Cl. A61J 1/03

(52) U.S. Cl. CPC A61J 1/035
USPC 206/531

(57) ABSTRACT

Embodiments of a blister sheet used to manage prescription pills are described herein and include a plurality of spaced-apart cavities, each surrounded by a flange on an open side of each cavity. The flanges together defining a top surface of the blister sheet. Two adjacent cavities are attached by adjacent sides of their respective flanges. Each of the adjacent sides having two longitudinal ends, each having a notch. When a sealing sheet is secured onto the top surface, the notches define unattached portions of the sealing sheet that can be used to grip onto the sealing sheet for its detachment from the top surface. The flanges of two adjacent individual blisters are joined by a tearing line that is weaker at the longitudinal ends thereof.

### BACKGROUND

The present disclosure relates to pills management.

More specifically, the present disclosure relates to a blister assembly for the storage and distribution of pills.

It is known in the art of pills management and distribution to use container-defining sheets also called blister sheets. Such sheets include cavities, arranged in line and columns, that are associated with moments in a day and which can be filled with prescription pills for subsequent ordered distribution to a user. The blister sheet is then sealed by a sheet that is inscribed with information pertaining to the pills in each cavity. The sealed blister sheet is such that, during distribution of the pills, each cavity can be conveniently detached.

Examples of a conventional blister sheet assembly is described in Canadian Patent No. 2,207,045, issued to Dispill Inc. in Jun. 1, 2009 and titled “Kit and Process for the Manufacture of a Set of Individual Pill Containers”.

A drawback of such a conventional blister sheet is that it is difficult for some disabled or weak user to detach a single blister from the rest, even when tearing lines are provided. Also, once that a single blister is detached, it is relatively difficult to open. Indeed, the sealing sheet portion is shaped and sized to precisely cover the top of the blister and there is no free portion of the sheet that a user can easily grip. The user has therefore no other choice that to tear the sealing sheet using a sharp object or by applying a strong enough force thereon.

The Canadian Patent No. 2,538,623, issued on Jan. 5, 2010, naming Bouthiette as the inventor and titled “Sealing Sheet for Used to Close a Container-Defining Sheet” aims at solving some of the above-mentioned drawbacks. According to this patent, the flange around each container of a container-defining sheet includes a recess, and a bottom layer of the sealing sheet assembly includes a small tab that is positioned within the recess when the container-defining sheet is sealed by the sealing sheet assembly. The tab is provided to ease peeling of the sealing sheet assembly from the container.

A first drawback of the assembly from Bouthiette is that the recess and tab are only provided on one side of the container. This forces a user to having first to found the tab before opening the container.

Also, the blister sheet assembly from Bouthiette shares the same drawback than the blister sheet assembly from Dispill Inc. with regards to the difficulty in detaching a particular blister from the remaining assembly.

### SUMMARY

An object of illustrated embodiments of a blister assembly is to provide means to facilitate the detachment of an individual blister from a sealed blister sheet.

Another object is to provide means to facilitate the opening of a detached blister.

More specifically, the separation and opening of a single blister from a blister sheet assembly according to illustrated embodiments is facilitated by providing a notch at each corner of the flange of the blisters.

In accordance with an illustrative embodiment, there is provided a blister sheet comprising:

a plurality of spaced-apart cavities, each surrounded by a flange on an open side of each cavity; the flanges together defining a top surface of the blister sheet; two adjacent cavities being removably attached by adjacent sides of their respective flanges; each of the adjacent sides having two longitudinal ends, each having a notch;

whereby, in operation, when a sealing sheet is secured onto the top surface, the notches define unattached portions of the sealing sheet that can be used to grip onto the sealing sheet for its detachment from the top surface.

According to another aspect a blister sheet assembly results from removably attaching a sealing sheet onto the top surface of the blister sheet for closing the cavities.

According to another embodiment, there is provided a blister comprising:

a cavity surrounded by a flange on an open side thereof; the flange defining a top surface of the blister; the flange having a plurality of sides, each having two longitudinal ends; at least one of the longitudinal ends having a notch;

whereby, in operation, when a cover sheet portion is secured onto the flange, each notch defining unattached portions of the cover sheet portion that can be used to grip onto the cover sheet portion for its detachment from the top surface.

According to still another embodiment, there is provided a sheet including at least one detachable portion that is joined to a remaining portion of the sheet by at least one tearing line, the improvement wherein the at least one tearing line being weaker at at least one longitudinal end thereof than near a center of the at least one tearing line.

According to a further embodiment, there is provided a blister sheet comprising a plurality of containers, each having a surrounding flange; adjacent containers being attached together by their flanges via a tearing line that is weaker at its two longitudinal ends; intersections of two tearing lines being provided with a hole that yields unattached portions for each cover pieces that is secured to a respective flange.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

The expression “blister sheet” is to be construed in the description and in the claims as to include a plurality of small containers assembled into a sheet, without restriction as to the material of the sheet or of the containers or how such a sheet is intended to be sealed or closed. The “blisters” should be construed herein as the containers included on the blister sheet.

The expression “cavity” is to be construed in the description and in the claims to include a device, etching, engraving or groove portions of an object, or else, that is capable of receiving and holding one or more small objects, such as without restrictions medication pills.

The expression “sealing sheet” is to be construed in the description and in the claims as including any thin member or assembly that cooperates with the blister sheet so as to close the cavities thereof and so as to prevent spillage of its content, which is not intended to be in liquid-form.

In the description and in the claims, the expression ‘ties’ refers to small attachments between two portions of a sheet and that form a tearing line between said two portions. Such ties can be formed, without limitations, by providing, along a line, perforations or dots as it is conventionally known.

Other objects, advantages and features will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a top perspective view of a blister sheet according to an illustrated embodiment;

FIG. 2 is a top plan view of the blister sheet from FIG. 1;

FIG. 3 is a front elevation of the blister sheet from FIG. 1;

FIG. 4 is a perspective view of an illustrative embodiment of sheet assembly used for sealing the blister sheet from FIG. 1;

FIG. 5 is a top perspective of the blister sheet from FIG. 1, shown in a sheet holder during the sealing of the blister sheet using the sheet assembly from FIG. 4;

FIG. 6 is a perspective view of the sheet assembly from FIG. 4 attached onto the blister sheet from FIG. 1 so as to form an illustrative embodiment of a blister sheet assembly;

FIG. 7 is a partial top perspective view of the blister sheet assembly from FIG. 6, showing one of the blister detached from the assembly;

FIGS. 8A to 8C are perspective views of the detached blister from FIG. 7, illustrating the peeling of the cover portion to open the blister; and

FIGS. 9A and 9B are perspective views of the detached blister from FIG. 7, illustrating the piercing of the sheet assembly portion to open the blister.

### DETAILED DESCRIPTION

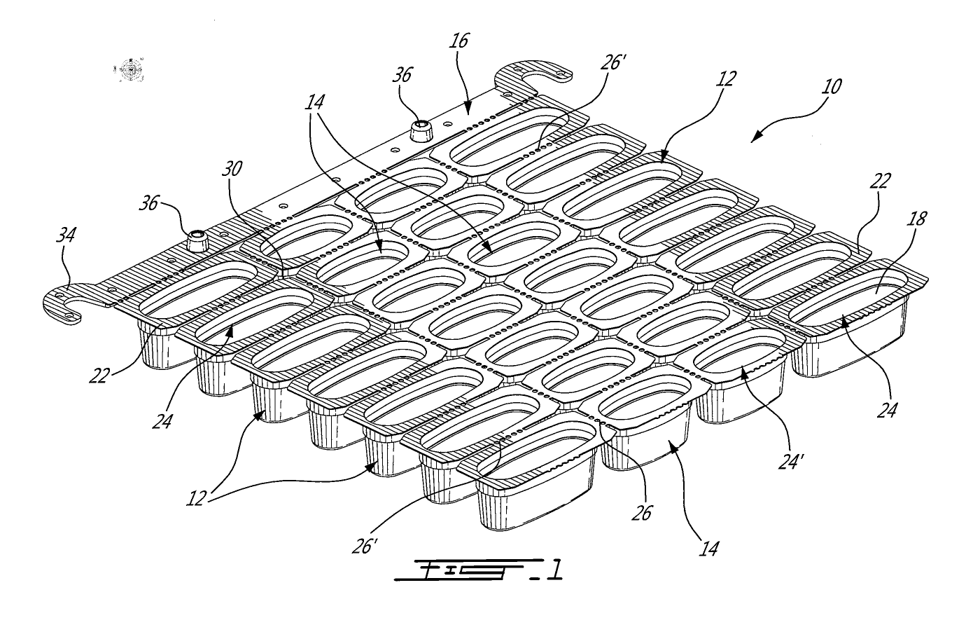

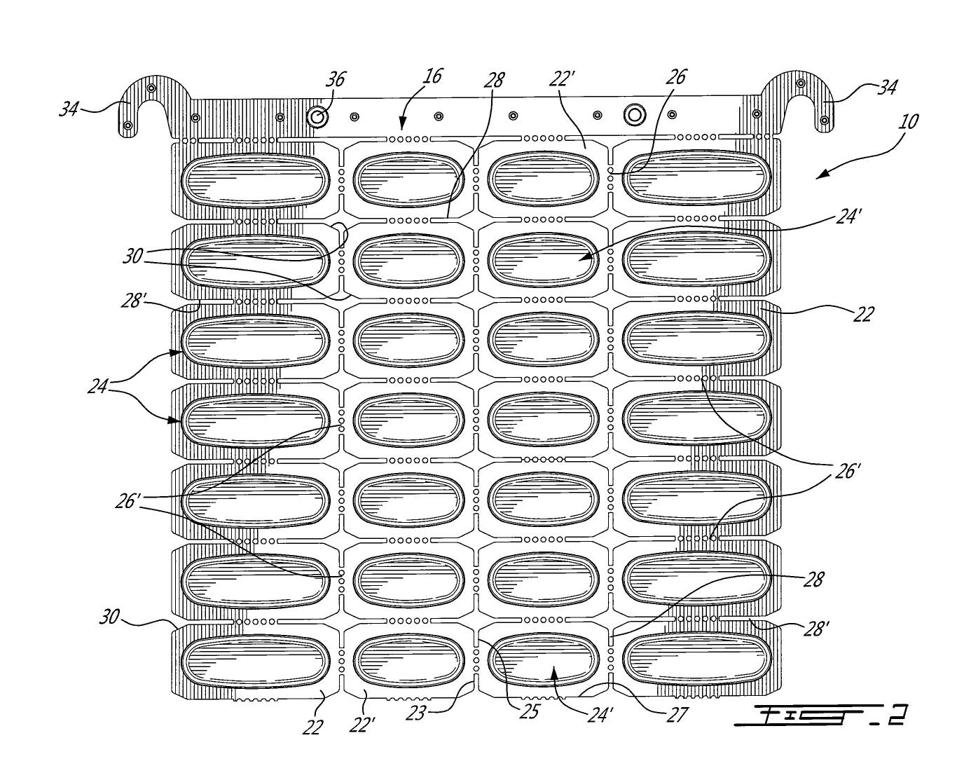

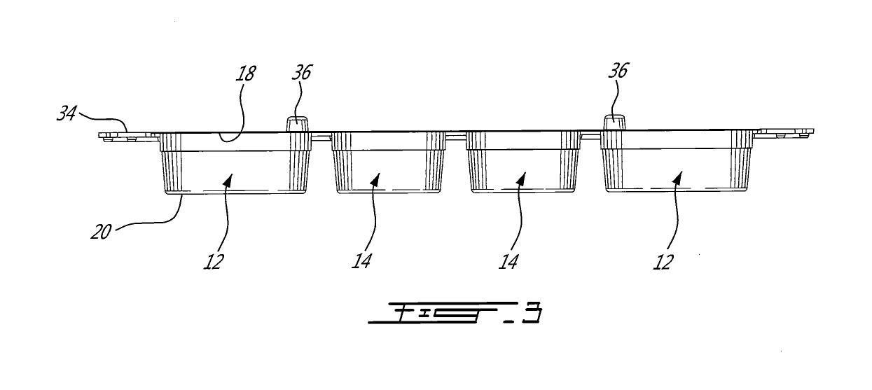

A blister sheet 10 according to a first illustrative embodiment will be described with reference to FIGS. 1 to 3. According to the illustrated embodiment, the blister sheet 10 is dimensioned for receiving and distributing prescription pills (not shown).

The blister sheet 10 comprises a plurality of spaced-apart cavities 12 and 14 arranged in seven (7) rows, one for each day of the week, and four (4) column, each for a different moment in day, such as morning, lunch, dinner and night. The blister sheet 10 further includes a tab 16 above the top row.

According to the first illustrated embodiment, the cavities 12 from the first and last columns are made bigger that the other cavities 14 so as to accommodate bigger pills and/or a greater number of pills. Indeed, as is often the case for an elder, the morning and night prescriptions, which are associated to the aforementioned cavities 12, usually include a greater number of pills 14 or bigger pills compared to other moments of the day.

As will become more apparent upon reading the following description, the blister sheet 10 is not limited to having the illustrated configuration. A blister sheet according to another embodiment (not shown) includes a different number of rows and/or columns that seven and four respectively. According to still another embodiment (not shown), the cavities are interconnected according to another arrangement than by rows and columns.

According to the first illustrated embodiment, the blister sheet 10 is a one-piece body made of a transparent, semi-transparent or opaque polymeric material, such as without limitations polypropylene, including homo polypropylene, copolymer, high or low density polyethylene, polyvinyl chloride (PVC), or polyethylene terephtalate.

According to a more specific embodiment, the blister sheet 10 is made of a biodegradable polymeric material.

According to still another embodiment, the blister sheet 10 results from a molding process. Since such a molding process is believed to be well known in the art, it will not be described herein in more detail for concision purposes.

Since the cavities 12 and 14 differ only by their size, only one of the cavity 12 from one of the external columns will be described herein in more detail. It is to be noted that, in the present description, the indicia prime (′) following a reference numeral is used to indicate a same part or a portion but of a different size than a part or a portion referenced by the same un-primed numeral.

Each cavity 12 has a generally oval-shaped cross-section that decreases from the opening 18 to the bottom 20 thereof. The cavity 12 is surrounded by a flange 22 that is leveled with the opening 18. The flange 22 is generally rectangular in shape that is defined by four sides. Together a cavity 12-14 with its surrounding flange 22 defines an individual blister 24-24′.

The opening sides of the cavities 12 and 14 are leveled and the flanges thereof together define a top surface of the blister sheet 10.

Each adjacent cavities 12 and 14 are attached by adjacent sides of their respective flanges 22-22′. Examples of such adjacent sides is the pair of sides 23-25. The attachment is in the form of a narrow bridge 26 or 26′ including small holes therein so as to yield a dotted tearing line. The tearing lines 26-26′ are centred relative to the length of the adjacent sides. The lengths of the tearing lines 26-26′ are such that they do not extend along the full length of both adjacent sides. This yields unattached portions 28-28′ on both sides of the tearing lines 26-26′.

The intersection of two adjacent sides of a flange 22-22′, such as sides 25 and 27, is cut so as to define a notch 30. The notches 30 increases the surface of the unattached portions 28-28′ on the top surface of the blister sheet 10.

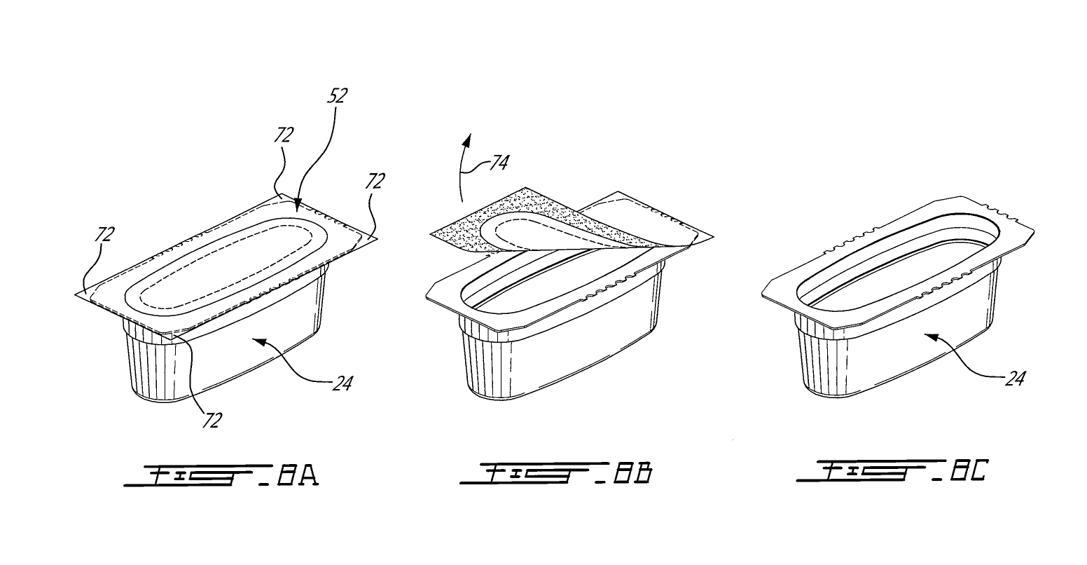

As will be described hereinbelow in more detail with reference to FIGS. 8A-8C, when a sealing cover 52 is secured onto the flange 22 or 22′ of a blister 24 or 24′, each notch 30 defines an unattached portion of the cover 52 onto the blister 24 or 24′ that can gripped for easy detachment thereof.

Regarding the unattached portions 28-28′, they have been found to ease the detachment of each individual blister 24-24′.

More generally, it has been found that a tearing line that has less dense ties and/or narrower ties at both its longitudinal ends than near its center, or no tie at both its longitudinal ends, is easier to tear than a tearing line that has identical ties along its full length and than a tearing line that has its weaker ties differently positioned than at its longitudinal ends.

Indeed, considering that a user usually grips a sheet portion for its detachment near one of the longitudinal ends of the tearing line, the force applied onto said tearing line in a direction which is not perpendicular to the tearing line increases with the distance of the hand therefrom. When the sheet is made of paper or of any tearable material, this often causes the detrimental tearing of the sheet along a direction transverse to the intended tearing line. This is in addition to the excess force that needs to be applied in such a case to start the tearing.

The tab 16 extends along the width of the sheet 10 and includes hook-like portions 34 that extend beyond the width of the sheet 10 at both longitudinal ends of the tab 16.

The tab 16 further includes two tenons 36 to be received in guiding holes 40 of the sealing sheet assembly 32. The tenons 36 and holes 40 cooperates to force the alignment of the sealing sheet assembly 32 with the blister sheet 10 as will be described hereinbelow in more details.

It is to be noted that other elements than the tenons 36 and holes 40 can be provided for aligning the sheets 10 and 32. According to other embodiments (not shown), such aligning elements, the hooks 34 and/or the tab 16 are omitted.

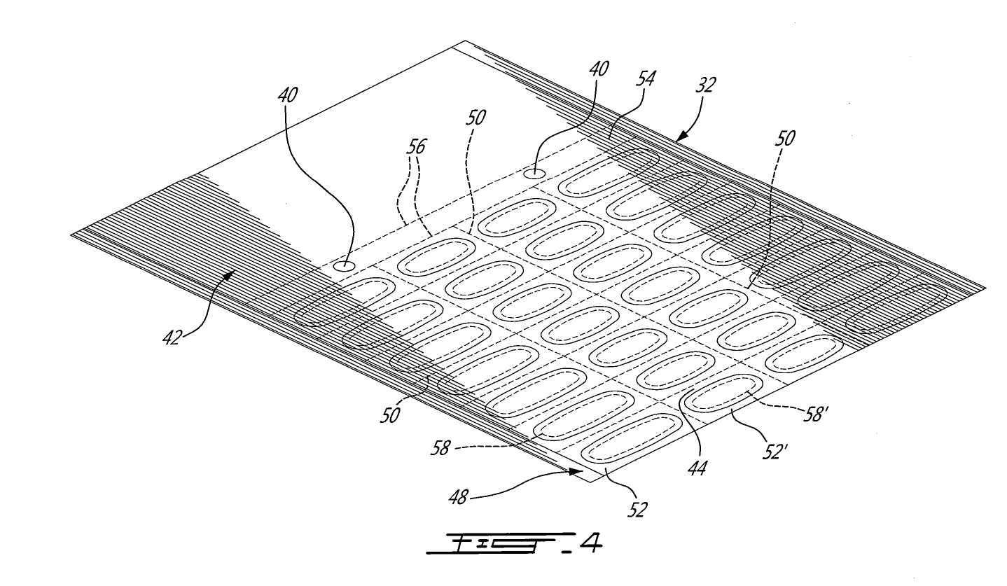

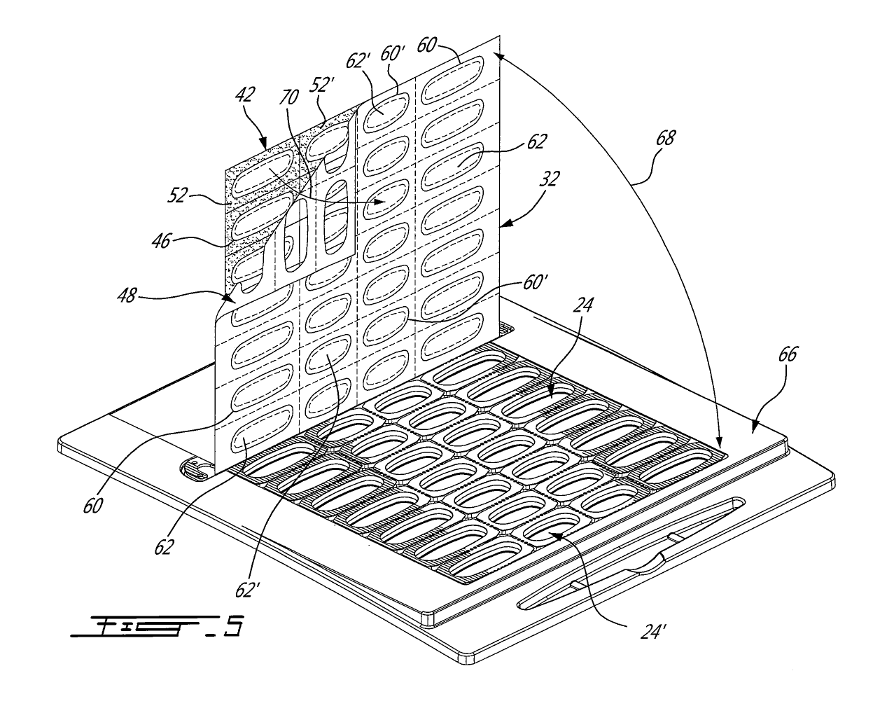

An illustrated embodiment of the sheet assembly 32 will now be described with reference to FIGS. 4 and 5. It is hereby reminded that a blister sheet according to an embodiment of the present invention can be sealed by single-layer or multi-layer sheets having other configurations and shapes than the sheet assembly 32. Also, even though the assembly 32 is made of paper, a blister sheet according to an embodiment of the present invention can be sealed by a sheet made of a polymeric material, a combination of paper and polymer, or else.

The sheet assembly 32 includes a cover layer 42 having a first side 44 suitable to receive information thereon and a second side 46 that includes an adhesive. The sheet assembly 32 further includes a peelable bottom layer 48 removably adhered to the cover layer 42. According to the illustrated embodiment, the peelable layer 48 extends from the cover layer 42 from both lateral side thereof so as to ease its removal therefrom. According to another embodiment (not shown), the peelable layer is similarly dimensioned than the cover layer.

The cover layer 42 includes first dotted tearing lines 50 that delineates cover pieces 52 and 52′. Each of the cover pieces 52 and 52′ is configured and sized so as to cover blisters 24 and 24′ respectively.

The cover layer 42 also includes a tab portion 54 that includes the afore-mentioned holes 40 and that is delineated by second dotted tearing lines 56. The tab portion 54 is configured and sized to be conformed with the tab 16 of the blister sheet 10.

The cover layer 42 further includes a top margin that allows the writing or printing of patient and/or prescription-related information.

The cover layer 42 further includes oval dotted tearing lines 58-58′, each generally centered within the cover pieces 52 and 52′ respectively. The oval dotted tearing lines 58-58′ define piercing areas therewithin.

The peelable bottom layer 48 includes tearing lines similar to those of the cover layer 42 and that are aligned with the tearing lines 50, 56 and 58-58′ of the cover layer 42.

In addition, the bottom layer 48 includes continuous oval-shaped tearing lines 60-60′ that are so configured and positioned as to surround one of the dotted oval-shaped tearing lines 58 and 58′ therein. The tearing lines 60-60′ define oval-shaped patches 62-62′.

Since the lines 60 and 60′ are continuous, the patches 62-62′ remain on the cover layer 42 when the bottom layer 48 is peeled therefrom. These patches 62-62′ allows preventing pills in the blisters 24-24′ from adhering onto the cover layer's 42 adhesive.

The sealing operation of the blister sheet 10, so as to yield a blister sheet assembly 64, will now be described in more detail with reference to FIG. 5.

After the cavities 12 are filled with selected prescription pills (not shown), the blister sheet 10 is first inserted in a support frame 66 that is configured to receive the blister sheet 10 therein in a snugly-fit manner so that movement of the blister sheet 10 relative to the frame are prevented or limited. It is to be noted that the support frame is not limited to the illustrated embodiment.

It is also to be noted that the blister sheet can be sealed without having recourse to a support frame, as the aligning means are provided on the blister and sealing sheets 10 and 32. When the blister sheet 10 is intended to be used without a support frame 66, the tab 16 can be provided with legs or support elements to maintain the tab 16 in a parallel relationship with the flanges 22 and 22′ when a downward force is applied thereon.

The tab portion of the peelable layer 48 is then removed and the two-layer sheet assembly 32 is positioned onto the blister sheet 10 and is aligned therewith by inserting the tenons 36 into the holes 40. The user then presses the tab portion 54 of the sheet assembly 32 onto the tab 16 of the blister sheet 12 so as to ensure a good adherence therebetween.

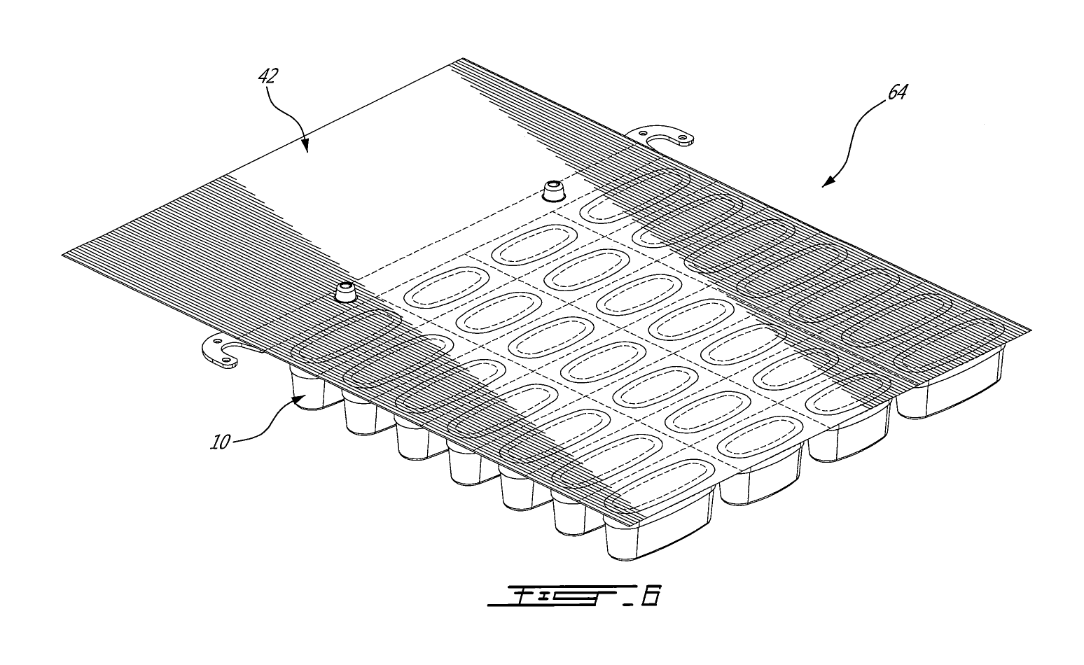

While the alignment of both sheets 10 and 32 is maintained by the above-described adherence between the tabs 16 and 54, the portion of the sheet assembly 32 that overlays the blisters 24-24′ is raised (see arrow 68) and the bottom layer 48 is peeled from the cover layer 42 (see arrow 70). As described hereinabove, the patches 62-62′ then remain on the cover layer 42. The portion of the sheet assembly 32 that overlays the blisters 24-24′ is then lowered (see arrow 68) and the user presses onto the sheet assembly 32 to improve the adherence of the sheet 32 onto the blister sheet 10 which is then sealed. The resulting blister sheet assembly 64 is shown in FIG. 6.

The blister sheet assembly 64 can then be handled and stored without the risk of losing pills or any other content of the cavities 12. For example the blister sheet assembly 64 can be hanged by the hooks 34 for vertical storage before distribution of the content thereof.

The blister sheet 10 can be sealed by other sealing sheet or sealing sheet assembly than the illustrated cover sheet 42. Also, the blister sheet 10 can be sealed by a cover sheet that is secured thereto by adhesive strips (not shown).

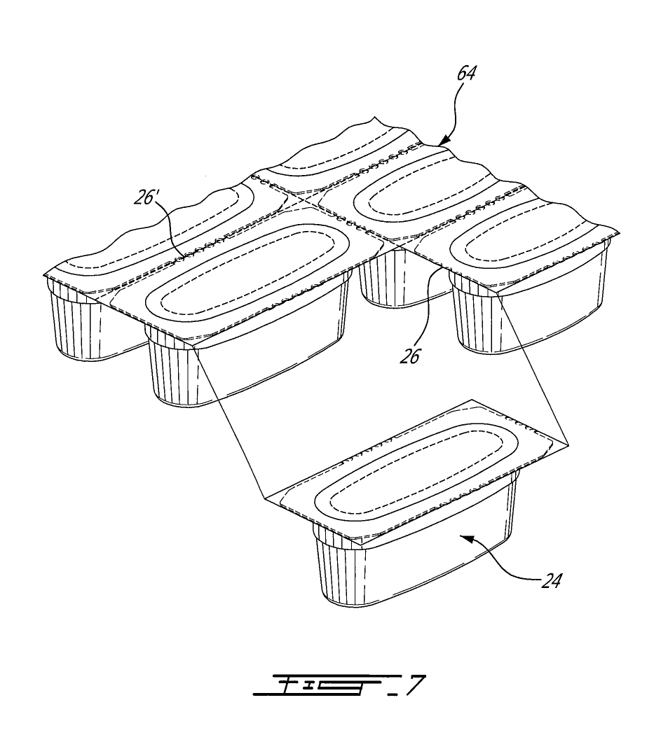

As can be seen in FIG. 7, an individual sealed blister 24 can be detached from the blister sheet assembly 64 by tearing along lines 26 and 26′. Since the cover sheet 42 is also provided with tearing lines 50 that are registered with the tearing lines 26-26′, the cover pieces 52 or 52′ is detached in unison with the corresponding blister 24-24′, yielding a detached sealed blister 24 or 24′. As described hereinabove, the separation of a blister 24 or 24′ is facilitated by the dotted tearing lines 26, 26′ being only at the center between two adjacent blister 24, 24′ with unattached portions 28-28′ on both sides of the tearing lines 26-26′.

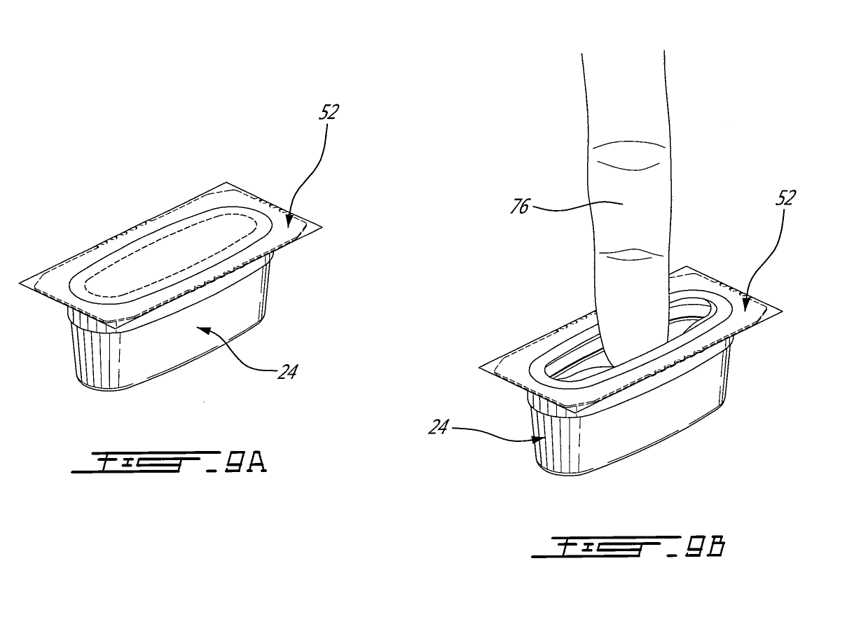

The configuration of the blister sheet assembly 64 allows two different opening methods of an individual blister 24 or 24′ as will now be described with reference to FIGS. 8A-8B and to FIGS. 9A-9B.

As shown in FIGS. 8A-8C, a sealed blister 24 can be opened so as to access its content by peeling the cover piece 52 attached thereto. This is achieved by the gripping of one of the four corners 72 of the cover piece 52 by a user that then only has to lift it while holding the blister 24 (see arrow 74). It is reminded that the four corners 72 are caused to be free by the notch 30. The person opening the blister 24 or 24′ is not require to hold it in any particular orientation since a notch 30, and therefore an unattached portion of the cover piece 52, are provided at each corner 72.

As can be seen in FIG. 9A-9B, a blister 24 or 24′ can be opened by piercing the cover piece 52 using the tip of a finger 76 or any moderately sharp object. Piercing of the cover piece is facilitated by the tearing line 58 or 58′.

It is to be noted that the receptacles are not limited to the illustrated oval shape. They can be round, rectangular, teardrop shaped, irregular, etc.

The notches provided at the corner of the flanges 22 and 22′ are not limited to being straight and can have other forms. For example, the flange can be oval or circular in shape, which would yield arcuate notches.

The blister sheet is not limited to receiving pills therein. More generally, it can be used for receiving any small, particulate or granular objects or matter.

The blister sheet is not limited to be in the form of a one-piece body and the cavities can be in the form of containers interconnected by their flanges. According to such an embodiment, the flanges of the cavities are provided with complimentary attaching elements that allow assembling a blister sheet having a given number of cavities. For example, such a blister sheet having two (2) columns and (7) rows is assembled for a patient whose prescription includes pills only for the morning and night.

It is to be understood that the blister sheet and blister sheet assembly are not limited in their application to the details of construction and parts illustrated in the accompanying drawings and described hereinabove. The blister sheet and blister sheet assembly are capable of other embodiments and of being practiced in various ways. It is also to be understood that the phraseology or terminology used herein is for the purpose of description and not limitation.

What is claimed is:

1. A blister sheet comprising:
a plurality of spaced-apart cavities, each surrounded by a flange on an open side of each cavity; the flanges together defining a top surface of the blister sheet; two adjacent cavities being removably attached by adjacent sides of their respective flanges; each of the adjacent sides having two longitudinal ends; each one of the two longitudinal ends having a notch;
whereby, in operation, when a sealing sheet is secured onto the top surface, the notches define unattached portions of the sealing sheet that can be used to grip onto the sealing sheet for its detachment from the top surface.

2. A blister sheet as recited in claim 1, wherein the plurality of spaced-apart cavities are arranged in at least one row.

3. A blister sheet as recited in claim 2, further comprising a tab mounted to a first one of the at least one row.

4. A blister sheet as recited in claim 2, wherein the plurality of spaced-apart cavities are further arranged in at least one column.

5. A blister sheet as recited in claim 4, wherein cavities in at least one of the column are bigger than other cavities.

6. A blister as recited in claim 2, wherein the plurality of spaced-apart cavities are arranged in seven (7) rows by four (4) columns; wherein the cavities in the first and last columns are bigger than the cavities in the second and third columns.

7. A blister sheet as recited in claim 1, wherein the flange has four sides.

8. A blister sheet as recited in claim 7, wherein the notches are provided at four corners of the flange.

9. A blister sheet as recited in claim 1, wherein the two adjacent cavities being removably attached by a dotted narrow bridge.

10. A blister sheet as recited in claim 1, wherein the two adjacent cavities being removably attached by a tearing line.

11. A blister sheet as recited in claim 10, wherein the two adjacent sides include two narrow gaps therebetween, each extending from a respective longitudinal end of the tearing line to a respective one of the two longitudinal ends.

12. A blister sheet as recited in claim 1, that is a one-piece body.

13. A blister sheet assembly comprising:
a plurality of spaced-apart cavities, each surrounded by a flange on an open side of each cavity; the flanges together defining a top surface of the blister sheet; two adjacent cavities being removably attached by adjacent sides of their respective flanges; each of the adjacent sides having two longitudinal ends, each having a notch; and
a sealing sheet removably attached to the top surface of the blister sheet for closing the cavities.

14. A blister sheet assembly as recited in claim 13, wherein the sealing sheet having first tearing lines registered with the adjacent sides and that delineate a cover piece for each of the plurality of cavities.

15. A blister sheet assembly as recited in claim 14, wherein the sealing sheet includes a second tearing line within each cover piece to ease piercing the cover piece.

16. A blister sheet assembly as recited in claim 13, wherein the plurality of spaced-apart cavities are assembled in rows and columns; the blister sheet assembly further comprising a tab mounted to the first row on a side thereof opposite a second row; the tab being provided with tenons that extend transversally from the tab; the sealing sheet including holes that are received in the tenons.

17. A blister sheet assembly as recited in claim 13, wherein the sealing sheet includes a patch under each of the cavities; the patch being configured and sized so as to complement the open side of the cavity.

18. A blister comprising:
a cavity surrounded by a flange on an open side thereof; the flange defining a top surface of the blister; the flange having a plurality of sides, each having two longitudinal ends; at least one of the longitudinal ends having a notch;
whereby, in operation, when a cover sheet portion is secured onto the flange, each notch defining an unattached portion of the cover sheet portion that can be used to grip onto the cover sheet portion for its detachment from the top surface.

19. A sheet including at least one detachable portion that is joined to a remaining portion of the sheet by at least one tearing line, the improvement wherein the at least one tearing line being weaker at at least one longitudinal end thereof than near a center of the at least one tearing line.

20. A blister sheet comprising:
a plurality of containers, each having a surrounding flange; adjacent containers being attached together by their flanges via a tearing line that is weaker at its two longitudinal ends; intersections of two tearing lines being provided with a hole that yields unattached portions for each cover pieces that is secured to a respective flange.
